(19) United States
(12) Patent Application Publication
(10) Pub. No.: US 2016/0288708 A1
(43) Pub. Date: Oct. 6, 2016

(54) INTELLIGENT CARING USER INTERFACE

(71) Applicant: Panasonic Automotive Systems Company of America, Division of Panasonic Corporation of North America, Peachtree City, GA (US)

(72) Inventors: WOOSUK CHANG, CUPERTINO, CA (US); ANGEL CAMILLE LANG, SAN JOSE, CA (US); MIKI NOBUMORI, SANTA CLARA, CA (US); LUCA RIGAZIO, LOS GATOS, CA (US); GREGORY SENAY, SANTA CLARA, GA (US); AKIHIKO SUGIURA, EAST PALO ALTO, CA (US)

(73) Assignee: Panasonic Automotive Systems Company of America, Division of Panasonic Corporation of North America

(21) Appl. No.: 15/085,761

(22) Filed: Mar. 30, 2016

Related U.S. Application Data
(60) Provisional application No. 62/140,312, filed on Mar. 30, 2015.

(51) Int. Cl. B60Q 9/00; B60W 40/08; G06K 9/00; B60R 1/00

(52) U.S. Cl. CPC B60Q 9/00; B60R 1/00; B60W 40/08; G06K 9/00845; B60W 2040/0818

(57) ABSTRACT

Exemplary embodiments of the present invention relate to an interaction system for a vehicle. The interaction system includes one or more input devices configured to receive data comprising a characteristic of a driver of the vehicle. The interaction system also includes one or more output devices configured to deliver an output the driver. The interaction system also includes a human machine interface controller. The human machine interface controller receives the data and analyzes the data to identify an emotional state of the driver. The human machine interface controller generates the output based, at least in part, on the emotional state of the driver and sends the output to the one or more output devices. The output includes a simulated emotional state of the human machine interface.

### CROSS-REFERENCE TO RELATED APPLICATIONS

This application claims the benefit of U.S. Provisional Application No. 62/140,312, filed on Mar. 30, 2015, which the disclosure of which is hereby incorporated by reference in its entirety for all purposes.

### FIELD OF THE INVENTION

The present invention generally relates to computing systems in a vehicle. More specifically, the present invention relates to a system architecture for integrating emotional awareness in a Human-Machine Interface (HMI) of a vehicle.

### BACKGROUND OF THE INVENTION

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Vehicles, such as cars, trucks, SUVs, minivans, among others, can have various systems that receive and respond to various input and provide information to the driver. For example, a vehicle safety system may have a number of sensors that receive information about the driving conditions of the vehicle, environmental conditions, driver status, and others. Such systems may be configured to alert the driver to potential hazards. Many vehicle have navigation systems which may display a user's location on a map, provide turn-by-turn directions, among other functionalities. An infotainment system may enable the driver to render various types of media, such as radio broadcasts, recorded music, and the others. Vehicles usually also have an instrument cluster that includes a speedometer, fuel gauge, odometer, various warning lights, and other features.

### SUMMARY OF THE INVENTION

An exemplary embodiment can include a human machine interface (HMI) for a vehicle. The HMI includes one or more input devices configured to receive data, including characteristics of a driver of the vehicle. The HMI also includes an HMI controller and one or more output devices configured to deliver an output the driver. The HMI controller is to receive the data, analyze the data to identify an emotional state of the driver, generate output based on the emotional state of the driver, and send the output to the output devices. The output includes a simulated emotional state of the HMI.

Optionally, the input devices can include haptic sensors disposed in a seat, an internal facing camera, an audio input system, and others. The data received may describe movement and positional characteristics of the driver, facial features of the driver, voice characteristic of the driver, and others. In some examples, the emotional state of the driver is selected from a set of emotional states including happiness, anger, boredom, sadness, and drowsiness.

The output generated by the HMI controller may include a visual representation of an avatar that exhibits the simulated emotional state of the human machine interface, an audio message from an avatar that exhibits the simulated emotional state of the human machine interface, a haptic output delivered to a seat belt to simulate a hug from an avatar, and others.

In another exemplary embodiment, a method for user and vehicle interaction includes receiving data from one or more input devices, including characteristics of a driver of the vehicle, analyzing the data to identify an emotional state of the driver, generating an output based, at least in part, on the emotional state of the driver, and sending the output to one or more output devices. The output includes a simulated emotional state of a human machine interface.

Another exemplary embodiment is a vehicle with a human machine interface for interaction with a user. The vehicle includes an ignition system and a plurality of input devices to acquire data, including a characteristic of a driver of the vehicle. The vehicle also includes a human machine interface controller configured to receive the data, analyze the data to identify an emotional state of the driver, generate an output based, at least in part, on the emotional state of the driver, and send the output to one or more output devices in the vehicle. The output includes a simulated emotional state of a human machine interface.

### BRIEF DESCRIPTION OF THE DRAWINGS

The above-mentioned and other features and advantages of the present invention, and the manner of attaining them, will become apparent and be better understood by reference to the following description of one embodiment of the invention in conjunction with the accompanying drawings, wherein:

FIG. 1 is a diagram of an example HMI system with emotional awareness.

FIG. 2 is an illustration showing features of an example avatar that may be employed in the HMI system.

FIG. 3 is another illustration showing examples of possible movements of an avatar that may be employed in the HMI system.

FIG. 4 is another illustration showing examples of possible emotional states exhibited by the avatar.

FIG. 5 is a block diagram of the HMI system.

FIG. 6 is a process flow diagram summarizing an example method 600 for operating an HMI with emotional awareness.

Correlating reference characters indicate correlating parts throughout the several views. The exemplifications set out herein illustrate a preferred embodiment of the invention, in one form, and such exemplifications are not to be construed as limiting in any manner the scope of the invention.

### DETAILED DESCRIPTION OF THE PREFERRED EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure describes an emotional awareness monitoring system for a vehicle. As explained above, vehicles often have various systems that receive and respond to various input and provide information to the driver, including vehicle safety systems, navigation systems, infotainments systems, instruments clusters, and others. The system described herein enables a Human-Machine Interface (HMI) of a vehicle to be responsive to the driver's emotional state. Various inputs can be received and processed to determine the emotional state of the driver. The received inputs may relate to the user's voice, face, how the driver is driving, and others. The determined emotional state of the driver can be used to provide a corresponding output to the user through the HMI. For example, the HMI can output a voice message to relax the driver if the driver seems agitated, or may output a voice message intended to entertain or otherwise engage a sleepy or bored driver.

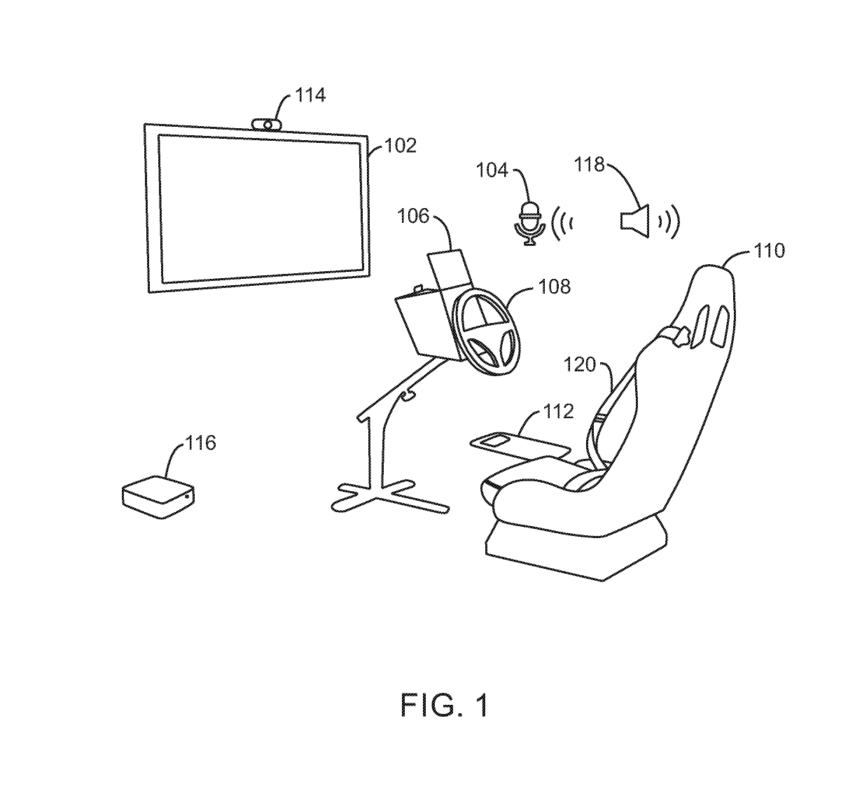

FIG. 1 is a diagram of an example HMI system with emotional awareness. In the example of FIG. 1, the HMI system 100 is employed in an automobile. However, the HMI system 100 could also be employed in other types of vehicles. The HMI system 100 includes can include a number of output devices, such as a display device 102, audio input system 104. The display device 102 may be a display screen on a center console and/or a head-up display 106 that projects an image onto the vehicle's windshield. The HMI system 100 may also include a number of sensors and haptic input devices configured to receive data about the driver. For example, the vehicles steering wheel 108 can be configured with sensors that perceive pressure applied by the driver. Additionally, the vehicle's seat 110 may include sensors that can detect movement of the driver, such as when the driver shifts his weight or position in the seat 110. The seat belt 120 as well as the driver's seat 110 may be configured to gather information about the user such as heart rate, body temperature, position, and posture.

Additionally, the HMI system 100 can also include a touch sensitive device 112 that is able to receive input from the driver. The touch sensitive device 112 may be positioned on a center console or other position that is easily accessible to the driver. The HMI system 100 also includes a camera 114 that faces the driver and is used to monitor the user's face.

The inputs received by the various input devices and sensors are sent to a computing device in the automobile, referred to herein as the HMI server 116. The HMI server 116 may be any suitable computing device and can include one or more processors as well as a computer memory that stores computer-readable instructions that are configured to analyze the inputs and generate an output to be received by the user. In some examples, the HMI server 116 may be integrated with a central server that provides most or all of the computing resources of the automobiles various systems. The HMI server 116 includes voice recognition and generation modules that provide Natural Language Processing and Text-to-Speech capabilities. The HMI server 116 senses an emotional state of the driver and renders an emotional behavior based on the user and the environment.

The emotional behavior generated by the HMI server 116 may be generated as an output to one or more output devices, including the display 102, the head up display 106, an audio output system 118, and other output devices. Some of the output devices may be haptic output devices. For example, the HMI system 100 may include a device that outputs a vibration the steering wheel 108 or the seat 110. In some examples, the haptic output may be delivered through a seatbelt 120 or the touch sensitive device 112. The emotional behavior can also be exhibited by an avatar rendered on a display.

As explained further below, the HMI system 100 can generate an avatar configured to assist and entertain the user and engage with the user to provide a unique driving experience. The avatar can be rendered through visual, audio, and haptic outputs. The avatar can develop over time by learning the user through interaction and speech. When the user first interacts with the avatar, the avatar will act like an assistant, and as the engagement increases over time the avatar's relationship with the user evolves onto more of a sidekick role, and lastly a friend/family role where it is more proactive. The avatar is friendly and intuitive, and expresses human-like emotions through movement, color, voice, and haptic. The avatar is designed to be conversational, and speaks in a gender and age neutral voice. The avatar has a personality, is humorous, has child-like wonders and excitement, and can express a range of emotions such as happiness, sadness, annoyance, impatience, or sullenness. The avatar is understanding, unique, sensitive, and adaptive, but not invasive, repetitive, or too opinionated. The avatar can be proactive, and initiate to take action or alter in mood independent of the user. For instance, the avatar provide emotive comfort, understanding, and entertainment to the user based on the emotional state of the driver.

The HMI server 116 may also be connected to the cloud and can gather data from the internet and any linked users, vehicles, households, and other devices. The HMI server 116 server can also obtain information about the environment surrounding the car including scenery, points-of-interest, nearby drivers, other HMI systems, and geo-location data. The HMI server 116 can also detect special events such as risk of accidents, rainbows, or a long road trip. Based on these data, the avatar is able to propose a unique experience that is relevant and personalized to the user.

The HMI system 100 is built specifically for users and their driving needs, and target users of all ages. The HMI system 100 can modify the behavior of the avatar based on the age and needs of the driver and passengers. Aspects of the HMI system 100 can also be implemented on other electronic devices, including mobile devices, desktop or laptop computers, or a wearable devices. The HMI system 100 can also be extended to a physical piece or an accessory that can visually represent the avatar, and can function as a component of the HMI system 100.

The HMI system 100 may sense the driver's emotion via one or a combination of the steering wheel 108, seatbelt 120, car seat 110, the audio input system 118, and the camera 114. The HMI system 100 renders emotion via one or a combination of the steering wheel 108, seat belt 120, car seat 110, audio output system 118, and visual display 102 such as the heads-up-display 106. Using various sensors, the system gathers information from the user, including facial data, expression, eye movement, body position, movement, and other data gather from the user's body. The combination of these components enables a personalized interaction with the HMI 100 system in real-time that creates a unified and emotional experience between the HMI system 100 and the user.

In some examples, the steering wheel 108 is configured as an emotional communication tool with various sensors and haptic out. The sensors may include pulse sensors, temperature sensors, pressure sensors, and others. The sensors enable the steering wheel to detect various states of the user such as emotion, fatigue, pulse rate, temperature, and EKG/ECG, which is then used by the HMI system 100 to provide appropriate assistance or communication to the user. The steering wheel 108 can also be used as an emotional rendering tool, and can alert the user of dangerous situations via haptic feedback, sound, and/or color. For example, the user can squeeze the steering wheel 108 provide an emotional input action that is intended to simulate giving a hug. The HMI system 100 can also generate an emotional output action that is intended to simulate a hug through another component of the system, such as the seat belt. The simulated hug can be accompanied by visual feedback and/or a sound effect. The emotional output action can be generated by inflation through an inflatable seatbelt or a similar device, or generated through a physical enclosure using the seatbelt, which will simulate a hug-like feeling.

The voice recognition and generation modules included in the server 116 enable the server 116 to use input from the user's voice and information from car sensors to interact intelligently with the user. The voice interaction can trigger the visual, audio, and/or haptic sensors, and create a cohesive emotional experience that works in unison in real-time. The voice generation module may be configured to generate a voice that may be child-like voice, ageless, or gender-neutral. In addition to voice interaction, the HMI system 100 can also use sound effects to interact with the user and audio to alert the user of dangerous situations. The HMI system 100 can also process content from the user's conversations and act on it appropriately, such as maintaining the user's schedule or searching on the Internet for information. For example, when the user is speaking on the phone about scheduling an appointment, the HMI system 100 may automatically note that on the user's calendar and provide a verbal reminder.

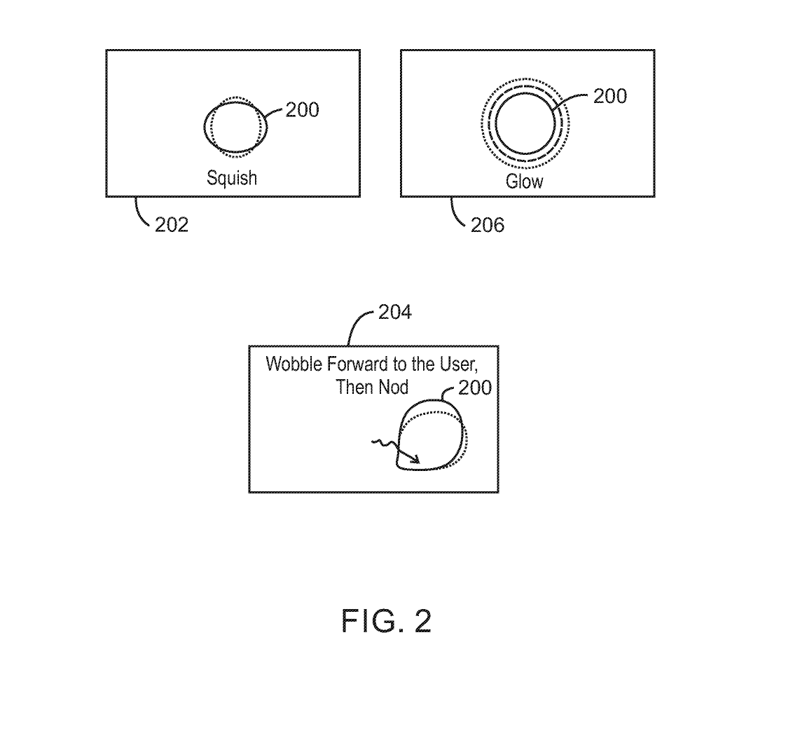

The HMI system 100 can generate some visual interactions in the form of an avatar. The avatar has a range of emotions and expresses them in variations of color, movement, facial expressions, and size. The HMI system's avatar can appear on the screen on any device that's linked to the HMI system 100. The position of the avatar may transition from screen to screen or device to device, to present transferred information. The avatar may be programmed to uses the entire screen space to interact and present information to create the impression that the avatar is residing inside a three-dimensional space and moving in and out to gather or present data to the user. In some examples, the avatar may be a simple abstract shape. An example of a generally circular but flexible avatar is shown in FIGS. 2-4. However, other shapes an avatar types are possible.

The HMI system 100 can also gather data from the user's eye gaze and gestures to try to provide more quick and accurate responses that are relevant to the user. For example when the user looks upward in the direction of the sky, the HMI system will determine from that gesture that the user may be interested in weather information and render the appropriate information. This technology may also be used in combination with an outside camera attached onto the car and/or geo-location data from the cloud, to intelligently interact with the user based on what the user may be looking at or thinking about in real-time while driving. The haptic touch control 112 may function as a set of buttons and can provide access to functionalities to the driver when necessary and reduce distraction while driving.

FIG. 2 is an illustration showing features of an example avatar that may be employed in the HMI system. The avatar 200 in the present example is a generally circular, but can also flex and adjust to exhibit certain emotional or interaction states. The three frames 202, 204, and 206 represent examples of the avatars visual characteristics. The frames 202, 204, and 206 may be rendered on any display device of the HMI system 100, including the display 102, the heads-up display 106, and others.

Frame 202 shows the avatar in an inactive state. The inactive state may occur when the avatar 200 is not actively engaging with user, although the HMI system 100 may still be monitoring the driver for user activity that will trigger engagement with the user. In frame 202, the avatar 200 is shown as an oblong shape, which creates the impression of a relaxed state.

The avatar 200 can be activated by voice keywords. The voice keywords may compose commands or a greeting to be spoken by driver to activate the avatar 200. The avatar 200 can also be activated by a gesture, eye movement, or a press of a button. Eye movement activation can involve a quick gaze towards the avatar display, possibly combined with a gesture or an immediate voice command. For example, the user could speak a command, such as “let's play some music.” The activation mechanism of the avatar 200 can be automatically personalized to the user in a way that creates a natural immediate interaction with the avatar 200, with very little to no time lag, similar to that of an interaction between people.

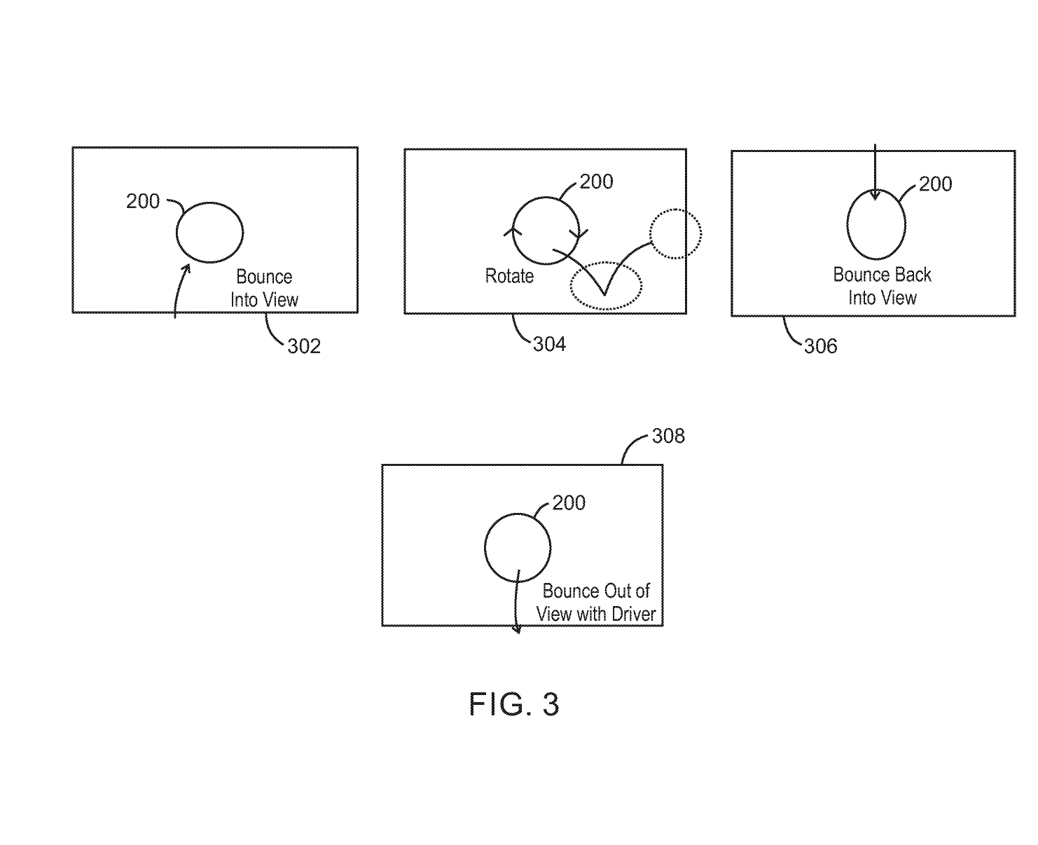

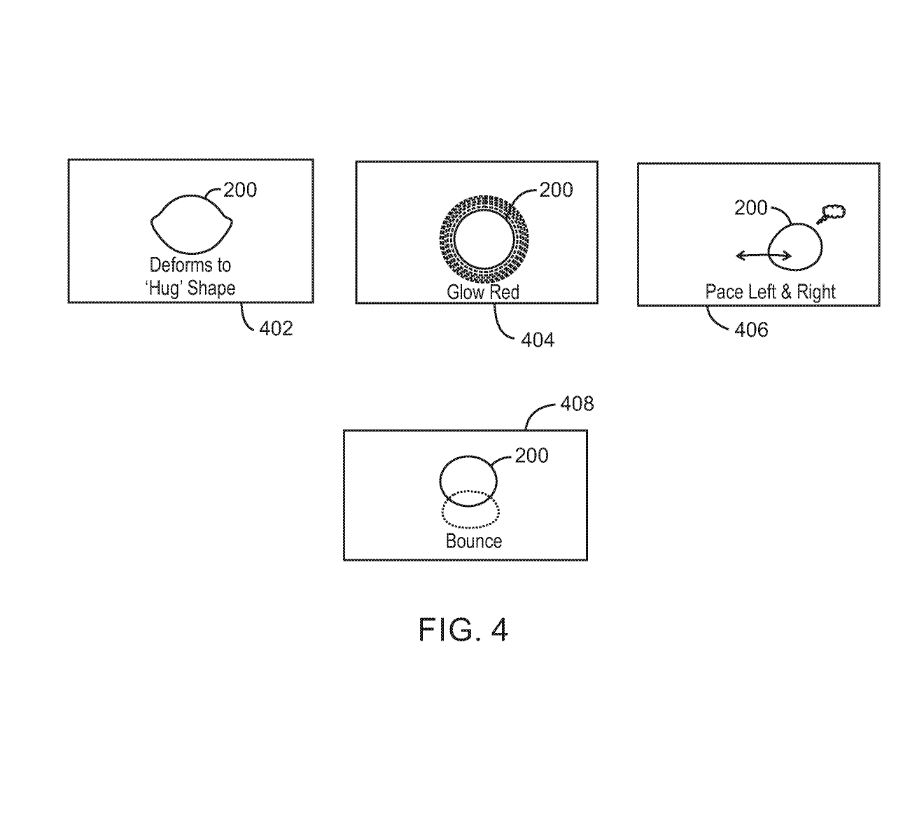

Once activated, the avatar 200 can have different visual presentations to indicate the avatar's state to the user. By default, the avatar 200 may be slightly transparent and floating in the center of the screen, possibly with some movement. When the avatar 200 is in a “listening” state, the avatar 200 may appear to wobble forward toward the user and nod while the user is talking, as shown in frame 204. When the HMI system 100 switches to a speaking state, the avatar 200 can indicate the speaking state, for example, by glowing intermittently, or generating wave like emanations, as shown in frame 206. Additionally, the avatar 200 different actions and emotions through a variety of movements including jumping, bouncing, squishing, pacing, and rotating, examples of which are shown in FIGS. 3 and 4. The avatar 200 can also be accessorized.

The avatar's emotional expression is also represented visually through variations in color. The avatar's color may change to represent different states of happiness, sadness, alertness, and a neutral state. The change in emotion is independent of the user, and can be affected by the user's interaction with the HMI system 100, the user's emotion based on data gathered from one or more of the sensors, the surrounding environment, and persons affiliated to the user, and/or external data collected from the cloud.

FIG. 3 is another illustration showing examples of possible movements of an avatar that may be employed in the HMI system. Frame 302 shows the avatar 302 bouncing into view. This action may be performed by the avatar, for example, when the user enters the automobile or when the user activates the avatar 200. Frame 304 shows the avatar 200 performing a rotating motion, which may be performed, for example, when the avatar 200 is receiving a command from the user or processing a command received by the user. Frame 304 also shows the avatar 200 bouncing off the screen, which may be performed, for example, to indicate processing activity by the HMI system 100. For example, the avatar 200 may bounce off screen to create the impression that the avatar 200 is leaving to retrieve information requested by the user.

Upon retrieval of the requested information, the avatar 200 bounces back into view, as shown in frame 306. The avatar 200 can also bounce from one display to another, for example, from the heads-up display 106 to a center console 102. Frame 308 shows the avatar 200 bouncing out of view of the driver to indicate farewell. For example, the avatar 200 may bounce out of view when deactivated by the user or when the user leaves the automobile.

FIG. 4 is another illustration showing examples of possible emotional states exhibited by the avatar. In some examples, the avatar 200 may be configured to simulate feelings of affection. For example, frame 402 shows the avatar 200 deforming into a hug-like shape 402. Frame 404 shows the avatar 200 glowing red to indicate caution or some alert condition. For example, the avatar 200 may exhibit caution in response to the presence of possible danger, such as stopped traffic ahead, and others. Frame 406 shows the avatar 200 exhibiting a back-and-forth pacing motion. The pacing motion may be performed to simulate a feeling of sulkiness, which may be performed, for example, to elicit interaction from the user. The avatar 200 may be triggered to elicit interaction with the user in response to the detected emotional state of the user. Frame 408 shows the avatar 200 bouncing, which may be performed to simulate feelings of excitement.

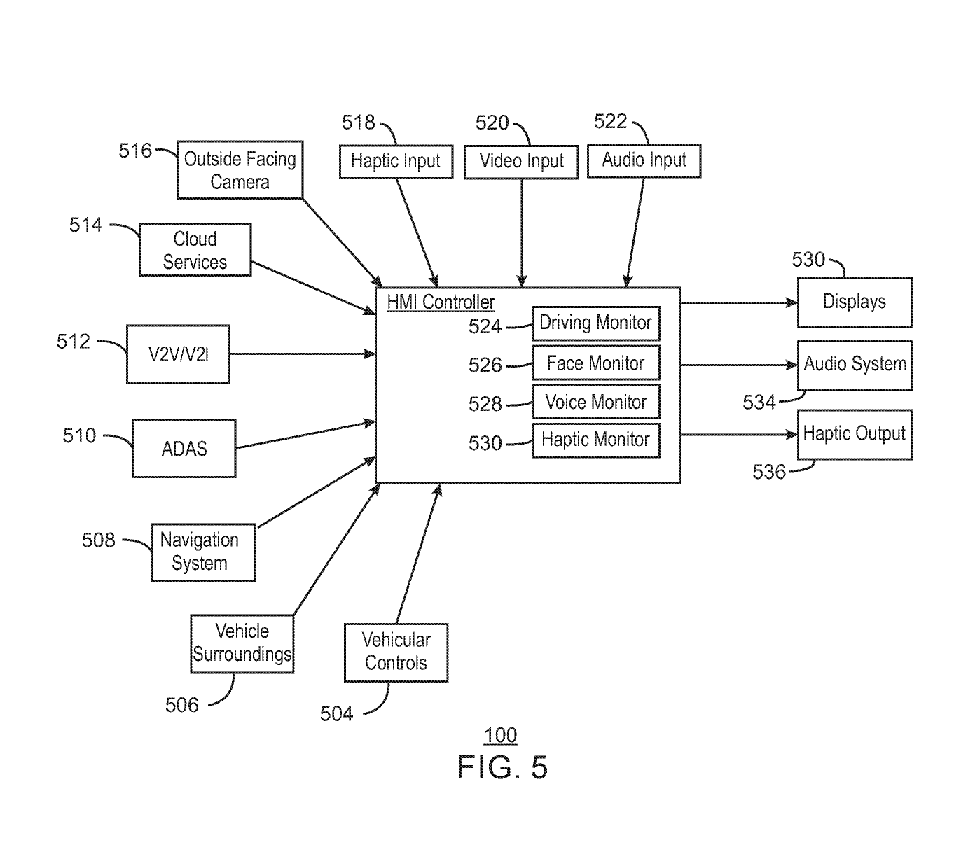

FIG. 5 is a block diagram of the HMI system 100. The HMI system 100 includes the HMI controller 502, which may be implemented in hardware or a combination of hardware and programming. The HMI controller 502 can reside on the server 116 shown in FIG. 1. The HMI controller 502 receives input from a variety of sources, including vehicular controls 504, vehicle surroundings sensors 506, the vehicles navigation system 508, an Advanced Driver Assistance System (ADAS) 510, vehicle-to-vehicle/vehicle-to-infrastructure (V2V/V2I) communication system 512, and cloud based services 514.

The HMI controller 502 can receive driver interaction information from the vehicular controls 504. The driver interaction information describes the driver interaction with the vehicles controls 504 including the steering wheel, accelerator, brakes, blinkers, climate control, radio, and others. This information may be used as an indication of a driver's state of mind.

The vehicle surroundings sensors 506 can provide information about objects in the vicinity of the automobile. For example, information received from the vehicle surroundings sensors 506 may indicate that an object is in the vehicle's blind spot, or that an object is behind the vehicle while backing up. The vehicle surrounding sensors 306 can also be used to indicate the presence of automobiles or other objects in front of the vehicle. The vehicle navigation system 508 can provide maps, driving directions, and the like.

The V2V/V2I system 512 enable the vehicle to communicate with other vehicles or objects in the vicinity of the vehicle. Information received through these communications can include traffic conditions, weather, conditions effecting safety, lane change warnings, travel related information, advertising, and others. The cloud services 514 can include substantially any service that can be provided over a network such as the Internet. Cloud services may include media services, entertainment, roadside assistance, social media, navigation, and other types of data. The cloud services 514 may be accessed through a network interface such as WiFi, cellular networks, satellite, and others. The ADAS system 510 can provide information about safety issues detected by the vehicle, including blind spot detection, collision avoidance alerts, emergency braking, and others.

Additional information that can be input to the HMI controller 502 includes data from an outside facing camera 516, haptic input 518, video input 520, and audio input 522. The outside facing camera may be aimed at the outside environment to gather information about the environment that is viewable by the driver or other passenger.

With reference to FIG. 1, the haptic input devices 518 may be employed in a steering wheel, seat 110, touch sensitive device 112, and others. The video input devices 520 are devices, such as camera 114, that obtain video image of the user. The video input devices 520 may gather video of the drivers face, for example. The audio input devices 522 can include one or more microphones 104 within the vehicle and configured to capture the user's voice.

The HMI controller 502 can include various modules for analyzing the information received from the vehicle sensors, input devices, and systems. The modules can include a driving monitor 524, a face monitor 526, a voice monitor 528, and a haptic monitor 530, and others.

The driving monitor 524 processes information from the vehicular controls 504 to generate a driver emotional state that takes into account all of the available information about the how the vehicle is being operated. For example, aggressive driving exhibited by fast acceleration, quick turns, and sudden decelerations, may indicate that the driver is in a hurry or perhaps late for an appointment.

The face monitor 526 can process the information from the video input devices 520 to analyze a driver's level of alertness or area of focus. For example, the face monitor 526 may receive a camera image of the driver's face and eyes and process the data to determine a direction of the user's eye gaze and/or whether the driver is drowsy.

The voice monitor 528 can process the information from the audio input devices 520 to identify commands, requests, and other interactions. The voice monitor 528 can also process the information from the audio input devices 520 to analyze the driver's mood, for example, whether the driver is bored, happy, or agitated.

The haptic monitor can process the information from the haptic input devices 518 to evaluate a driver's emotional state or receive input commands and actions from the driver. For example, a haptic sensor in the steering wheel can sense a simulated hug from the driver, which may be used an indication of approval from the drive to the avatar. Haptic sensors in the seat and seat belt may be used to determine if the user is generally still and relaxed or uncomfortable and agitated.

The driver emotional state is used by the HMI controller 502 to generate a corresponding HMI output, which may include an simulated emotional state. The HMI output may be delivered to one or more of the displays 530, the audio system 534, and the haptic outputs 536. With reference to FIG. 1, the displays 530 can include the display 102, the head-up-display 106, and others. The audio system 534 may be the audio system 118, which may be integrated with the automobile's media player (AM/FM radio, Compact disc player, satellite radio, etc.) or a separate audio system dedicated to the HMI 502. The haptic outputs may be integrated into one or more of the steering wheel 108, seat 110, seat belt 120, and the touch sensitive device 112.

The HMI output can cause the displays 530, audio system 534, and haptic outputs 536 to exhibit an emotional state in a variety of ways. For example, the HMI output may include one or more visual characteristic of the avatar as described in FIGS. 2-4. The HMI output can also include an audio message that replicates a verbal message from the avatar. For example, if the driver's emotional state suggests agitation, the avatar may deliver a calming message or a polite request to drive more safely. The HMI output can also trigger a haptic response, such as a vibration delivered to the seat or steering wheel. For example, if the driver's emotional state suggests that the driver is distracted or drowsy, the seat or steering wheel may vibrate to arouse the driver.

The HMI output may also include a combined response that involves some or all of the displays 530, the audio system 534, and the haptic output 536. In some examples, the avatar's visual appearance may be changed while the avatar simultaneously delivers an audio message and a haptic response. For example, if the emotional state of the driver suggests drowsiness, the avatar may bounce in excitement as shown in frame 408 (FIG. 4) while also delivering a playful audio message and vibrating the seat.

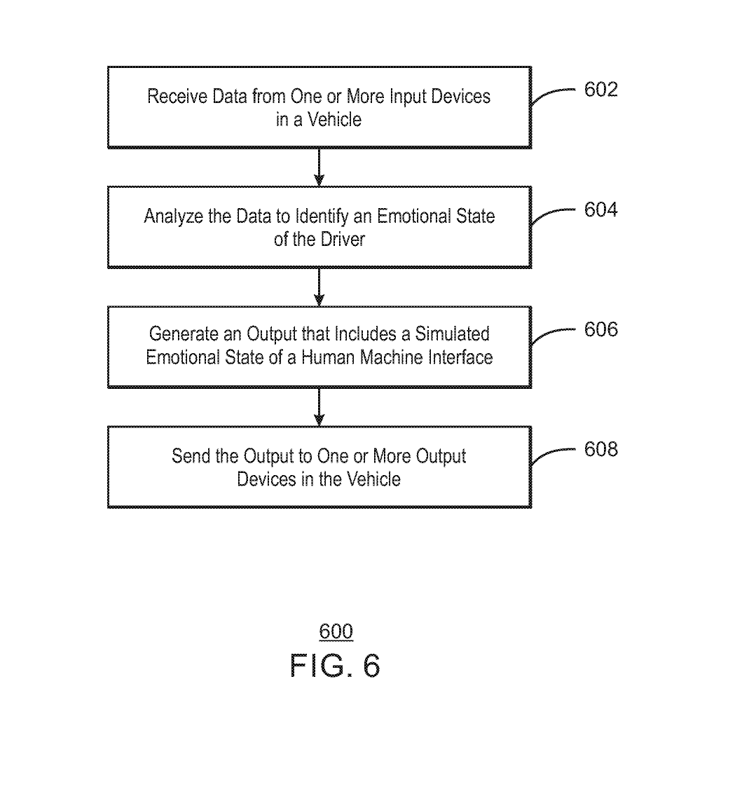

FIG. 6 is a process flow diagram summarizing an example method 600 for operating an HMI with emotional awareness. Process flow begins at block 602. The method 600 may be performed by a component of a vehicle such as the HMI controller 502 shown in FIG. 5.

At block 602, data is received from vehicle input devices. The vehicle input devices include any type of sensor or system that can generate information useful for monitoring a driver, a vehicle, or conditions inside or outside the vehicle. For example, the input devices may include a camera, an ADAS system, a navigation system, cloud based service, microphones, haptic input devices, and other sensors.

The data can include, but is not limited to, a characteristic of a driver of the vehicle. For example, data received from one or more haptic sensors disposed in a seat may describe movement and positional characteristics of the driver. Data received from an internal facing camera may include a facial feature of the driver. Data received from an audio input system, and the data describes a voice characteristic of the driver.

At block 604, the data is analyzed to identify an emotional state of the driver. The emotional state of the driver may be identified by selecting the emotional state from a predefined set of emotional states, such as happiness, anger, boredom, sadness, drowsiness, and others.

At block 606, an output is generated based, at least in part, on the emotional state of the driver. The output can includes a simulated emotional state of the human machine interface.

At block 608, the output is sent to one or more output devices, including display devices, audio systems, haptic output devices, or a combination thereof. For example, sending the output to the output devices can include rendering a visual representation of an avatar, and or an audio message from the avatar, and a haptic output intended to simulate a physical interaction with the avatar. The visual, audio, and haptic interactions can each exhibit the simulated emotional state of the human machine interface. For example, haptic output delivered to a seat belt may be used simulate a hug from the avatar.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A human machine interface for a vehicle, comprising:
one or more input devices configured to receive data comprising a characteristic of a driver of the vehicle;
one or more output devices configured to deliver an output the driver; and
a human machine interface controller configured to:
receive the data and analyze the data to identify an emotional state of the driver;
generate the output based, at least in part, on the emotional state of the driver, wherein the output comprises a simulated emotional state of the human machine interface; and
send the output to the one or more output devices.

2. The human machine interface of claim 1, wherein the one or more input devices comprise haptic sensors disposed in a seat, and the data describes movement and positional characteristics of the driver.

3. The human machine interface of claim 1, wherein the one or more input devices comprises an internal facing camera, and the data describes a facial features of the driver.

4. The human machine interface of claim 1, wherein the emotional state of the driver is selected from a set of emotional states comprising happiness, anger, boredom, sadness, and drowsiness.

5. The human machine interface of claim 1, wherein the one or more input devices comprises an audio input system, and the data comprises a voice characteristic of the driver.

6. The human machine interface of claim 1, wherein the output comprises a visual representation of an avatar that exhibits the simulated emotional state of the human machine interface.

7. The human machine interface of claim 1, wherein the output comprises as audio message from an avatar, wherein the audio message exhibits the simulated emotional state of the human machine interface.

8. The human machine interface of claim 1, wherein the output comprises a haptic output delivered to a seat belt to simulate a hug from an avatar.

9. A method for user and vehicle interaction, comprising:
receiving data from one or more input devices, the data comprising a characteristic of a driver of the vehicle;
analyzing the data to identify an emotional state of the driver;
generating an output based, at least in part, on the emotional state of the driver, wherein the output comprises a simulated emotional state of a human machine interface; and
sending the output to one or more output devices.

10. The method of claim 9, wherein receiving input from one or more input devices comprises receiving the input from one or more haptic sensors disposed in a seat, and the data describes movement and positional characteristics of the driver.

11. The method of claim 9, wherein receiving input from one or more input devices comprises receiving the input from an internal facing camera, and the data comprises a facial feature of the driver.

12. The method of claim 9, wherein analyzing the data to identify the emotional state of the driver comprises selecting the emotional state from a set of emotional states comprising happiness, anger, boredom, sadness, and drowsiness.

13. The method of claim 9, wherein receiving input from one or more input devices comprises receiving the input from an audio input system, and the data describes a voice characteristic of the driver.

14. The method of claim 9, wherein sending the output to the one or more output devices comprises rendering a visual representation of an avatar that exhibits the simulated emotional state of the human machine interface.

15. The method of claim 9, wherein sending the output to the one or more output devices comprises rendering an audio message from an avatar, wherein the audio message exhibits the simulated emotional state of the human machine interface.

16. The method of claim 9, wherein sending the output to the one or more output devices comprises triggering a haptic output delivered to a seat belt to simulate a hug from an avatar.

17. A vehicle with a human machine interface for interaction with a user comprising:
an ignition system;
a plurality of input devices to acquire data comprising a characteristic of a driver of the vehicle;
a human machine interface controller configured to:
receive the data and analyze the data to identify an emotional state of the driver;
generate an output based, at least in part, on the emotional state of the driver,
wherein the output comprises a simulated emotional state of a human machine interface; and
send the output to one or more output devices in the vehicle.

18. The vehicle of claim 17, wherein the data is received from one or more haptic sensors.

19. The vehicle of claim 17, wherein sending the output to the one or more output devices comprises rendering a visual representation of an avatar that exhibits the simulated emotional state of the human machine interface.

20. The vehicle of claim 17, wherein sending the output to the one or more output devices comprises rendering an audio message from an avatar, wherein the audio message exhibits the simulated emotional state of the human machine interface.
